(19) United States
(12) Patent Application Publication
(10) Pub. No.: US 2002/0091628 A1
(43) Pub. Date: Jul. 11, 2002

(54) Credit granting system and credit applying method using the system

(76) Inventor: Koki Kunimatsu, Tokyo (JP)

Correspondence Address: McDERMOTT, WILL & EMERY, 600 13th Street, N.W., Washington, DC, 20005-3096, US

(21) Appl. No.: 09/949,893

(22) Filed: Sep. 12, 2001

(30) Foreign Application Priority Data
Sep. 11, 2000 (JP) 2000-274782

(51) Int. Cl. G06F 17/60

(52) U.S. Cl. 705/38

(57) ABSTRACT

The present invention provides a credit granting system wherein a user is immediately informed of the availability of credit to be granted from a plurality of financial institutions, and able to get a loan with a most preferable condition, and further wherein a financial institution can obtain an application information concerning a loan or the like from many user, and able to make a transaction with a user who conforms with its criteria for credit granting.

The credit granting system of the present invention comprises a user's computer capable of transmitting both an information item and a data piece, which are required for providing a credit, and capable of receiving a judgment result information as to whether or not the credit can be provided; and a business operator's computer connected via a communications line to the user's computer, capable of receiving the information item and the data piece transmitted from the user's computer, analyzing the received information item and data piece, comparing the analyzed result with a condition for credit provision which has been previously given by a financial institute, judging whether or not the credit can be provided, and transmitting the judgment result information to the user's computer.

### BACKGROUND OF THE INVENTION

1. Field of the Invention

The present invention is related to a credit granting system wherein one-time provision of information enables asking a plurality of financial institutions credit availability and a condition for financing, and receiving the financing under the most advantageous condition.

2. Description of the Related Art

In the case that a corporation or a small business owner which runs a business, or an individual (hereinafter referred to as a “user”) gets a loan from a financial institution such as a bank or a lease company in order to expand there business or avoid an instant money shortage for business operation, or to purchase a house, the user submits, in general, a copy of a financial statement or a final tax return document filed into a tax office, and further other documents such as an income certificate, to the financial institution which has a usual transaction with the user. After receiving the above documents necessary for the loan, the financial institution decides whether or not providing the loan, and presents a condition in the case of providing the loan, depending upon criteria predetermined by the financial institution.

According to the above conventional system, where the user who attempts to get the loan, sounds out a plurality of financial institutions about the loan availability, the user has to submit some documents each having almost the same contents to respective financial institutions. Considering a cumbersome preparation for these documents, the user's choice, in many cases, may be limited to a financial institution with which the user has a usual transaction, even when there exists other financial institution from which the user can get the loan with an advantageous condition. Thus, it is very difficult to obtain the loan with an advantageous condition. Also, the financial plan for the user may be disturbed when receiving a rejection for the loan from one financial institution, because it takes a certain length of time for one financial institution to reach a decision on the loan availability.

On the other hand, whenever the financial institution receives an application for the loan from the user, the financial institution examines contents of the submitted documents, and needs to make judgment on whether or not the user meets the criteria of that financial institution on a one-by-one basis. Therefore, it takes time for examination. Moreover, that financial institution is obliged to report the examination result to the user, and in many cases, it is required to electronify and hold the submitted documents at its own expense, consequently spending a lot of time and expenses for managing the documents. There are still many things to be improved.

On the other hand, in such a financial institute which accepts loan requests issued from users, this financial institute must investigate contents of documents submitted every time these users issue loan requests and must judge as to whether or not these loan requests can satisfy the own loan condition of this financial institute with respect to each of these users. As a result, this financial institute necessarily requires lengthy investigation time, and has a duty to notify the judgement results to the respective users. There are many possibilities that contents of documents submitted from these users should be stored in the form of electronic data into this financial institute, resulting in various problems. That is, both lengthy time and large expense would be required to manage these documents.

### SUMMARY OF THE INVENTION

In view of the foregoing, according to the present invention, there is provided a credit granting system wherein;

a user who wishes to obtain a loan, can smoothly be notified, from a plurality of financial institutions, of whether or not the financial institutions can grant the loan, and at the same time the user can obtain the loan with a most preferable condition:

the financial institutions which provide the loan, are able to obtain financial product-related application information from many users, and the financial institutions make a transaction with only a user who conforms with their credit standard, resulting in their effective business operation.

In order to achieve the above-described object, the credit granting system of the present invention comprises:

a user's computer capable of transmitting both an information item and a data piece, which are required for providing a credit, and capable of receiving a judgment result information as to whether or not the credit can be provided; and

a business operator's computer connected via a communications line to the user's computer, capable of receiving the information item and the data piece transmitted from the user's computer, analyzing the received information item and data piece, comparing the analysis result with a condition for credit provision which has been previously given by a financial institute, judging whether or not the credit can be provided, and transmitting the judgment result information to the user's computer.

This system allows a user to apply for credit granting to a plurality of financial institutions by one-time processing operation, although conventionally, the user submits to each financial institution data such as a loan application form, a financial statement or the like in the form of paper in order that the user gets a loan from some of the financial institutions. Simultaneously, when the user obtains a plurality of credits granting, the user can compare and review a condition for each credit, so that the user can make a transaction with a financial institution providing a most preferable condition. On the other hand, the financial institutions can promote their products to a potential client without one-by-one sales operation, and can shorten a term required for examination process for credit granting.

Further, according to the present invention, there is provided a credit granting method, which utilizes the above-described credit granting system.

### BRIEF DESCRIPTION OF THE DRAWINGS

For a better understanding of the present invention, reference is made of a detailed description in conjunction with the accompanying drawings, in which:

FIG. 1 is a conceptual view for illustrating a credit granting system according to the present invention; and

FIG. 2 is a flow chart for describing a process of the credit granting system on a user's side.

### DETAILED DESCRIPTION OF THE PREFERRED EMBODIMENTS

Referring now to drawings, various preferred embodiments of the present invention will be described in detail.

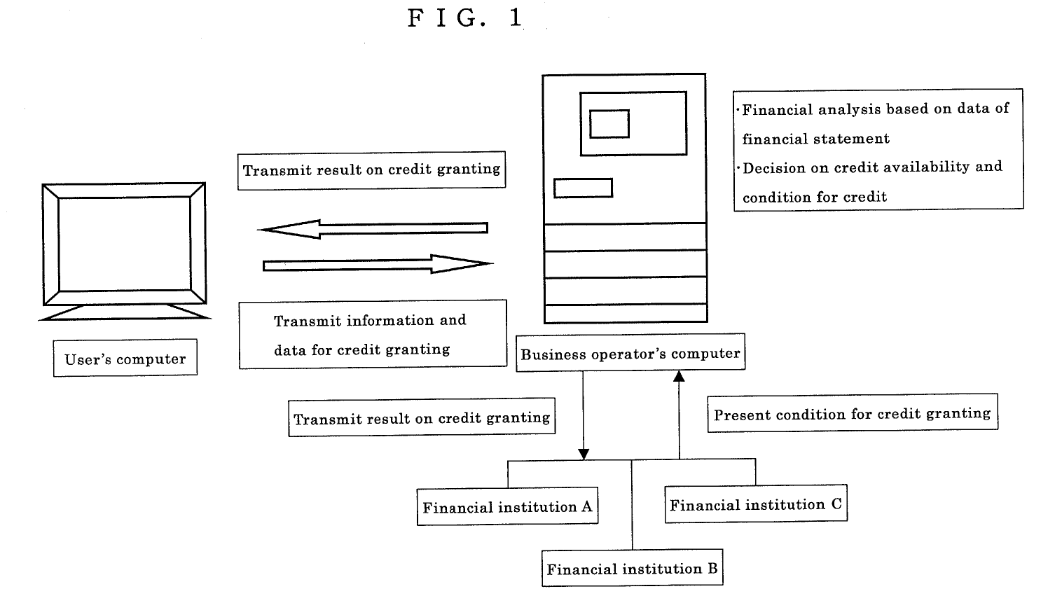

As shown in FIG. 1, a credit granting system of the present invention is comprised of a user-computer and a business-operator's computer connected thereto via a communications line.

In order to get from a financial institution a loan such as a business loan and a housing loan, the user's computer is provided with functions of transmitting information pertaining to a desired loan condition or the like, and data described in a financial statement or a final tax return, which are required for a loan application, and of receiving a resultant decision as to credit granting.

The business-operator's computer receives the information and data transmitted from the user, analyzes a user's financial faculty (financial condition) based on the received information and data, compares the analysis result with data which has been previously given from a financial institution for use in judging whether or not a credit is granted, and determines whether or not a credit is granted. The business-operator's computer is provided with a reception unit for receiving the information and data, an analysis unit for analyzing a financial condition based on the data, a unit for storing information previously given by the financial institution for judgment of credit granting and for updating the stored information if necessary, a selection unit for selecting a financial institution which decides to grant credit to the user, and transmission unit for transmitting the thus obtained result concerning credit granting to the user's computer.

In this credit granting system, a “user” means an individual, a small business owner, or a corporation, which needs a credit in order to get a loan. The user transmits to the business-operator's computer information including a desired loan condition such as a necessary loan amount, a purpose thereof and a repayment period, together with an income-certifying document, for example, a salary income certificate for an individual, a final tax return for a small business owner, and a financial statement for a corporation.

Herein, the business-operator means an intermediator between the user and the financial institution such as a bank, a credit company, or a lease company. Based on the information which is previously given by the financial institution for the judgment of credit granting, the business-operator analyzes the information and data provided from the user, judges the possibility of credit granting, and notifies the user and the financial institution of the judgment result. The business-operator may make a distributor contract with the financial institution. Then, the business-operator collects a necessary commission fee from the user and/ or the financial institution, when an agreement is established between the user and the financial institution. In this case, there is no specific limitation for the payment of the commission fee.

Here, it should be understood that a financial product, which grants credit, includes a financing product, a lease product, an installment product, and an insurance product.

Further, even except in cases where the agreement is established, when the business-operator provides a user-related information or data for the judgment of credit granting to the financial institution, the business-operator may request the payment of a necessary commission fee.

Although there is no particular limitations as to financial analysis for credit granting, in general, the following three items, that is soundness, profitability, and growth potential of financial condition, are utilized, by converting them into numerical expressions system or a point system, as judgment criteria for granting credit. This information, as a matter of course, is provided in advance from the business-operator to each financial institution.

Figures on financial soundness

| | |
|---|---|
| 1. | Ratio of current expenses to current income |
| 2. | Current ratio |
| 3. | Quick ratio |
| 4. | Fixed asset ratio |
| 5. | Fixed Assets/(Shareholders′Equity + long-term Liabilities) |
| 6. | Debt loan to gross capital |
| 7. | Interest coverage ratio |
| 8. | Equity ratio |
| 9. | Liquidity in hand |
| 10. | Inventory turnover period |
| 11. | Receivables turnover period |
| 12. | Payables turnover period |
| 13. | Depreciation rate |
| 14. | Currency period for long-term loan |
| 15. | Profit retention ratio |
| | (Figures on financial profitability) |
| 16. | Ratio of gross profit to net sales |
| 17. | Ratio of ordinary profit to net sales |
| 18. | Ratio of sales and general administrative expenses to net sales |
| 19. | Return on investment |
| 20. | profit rate of total liabilities and net worth before allowance and |
| | amortization |
| 21. | Break-even point rate |
| 22. | ROE (return on equity) |

Figures on financial growth potential

| | |
|---|---|
| 23. | Turnover growth rate |
| 24. | Ordinary profit growth rate |
| 25. | Total assets growth rate |

The business-operator converts the information and data provided from the user into numerical expression system and point system by the use of a methodology of the above financial analysis, and then the business-operator make judgment on user's availability of credit granting in accordance with the credit criteria preliminarily obtained from the financial institution. Moreover, the credit to be granted may be limited to a certain range, and therefore when the credit granting is decided, the business-operator also makes judgment on an interest rate of the credit and a term thereof, a necessity of collateral for the credit, and a necessity of a guarantor.

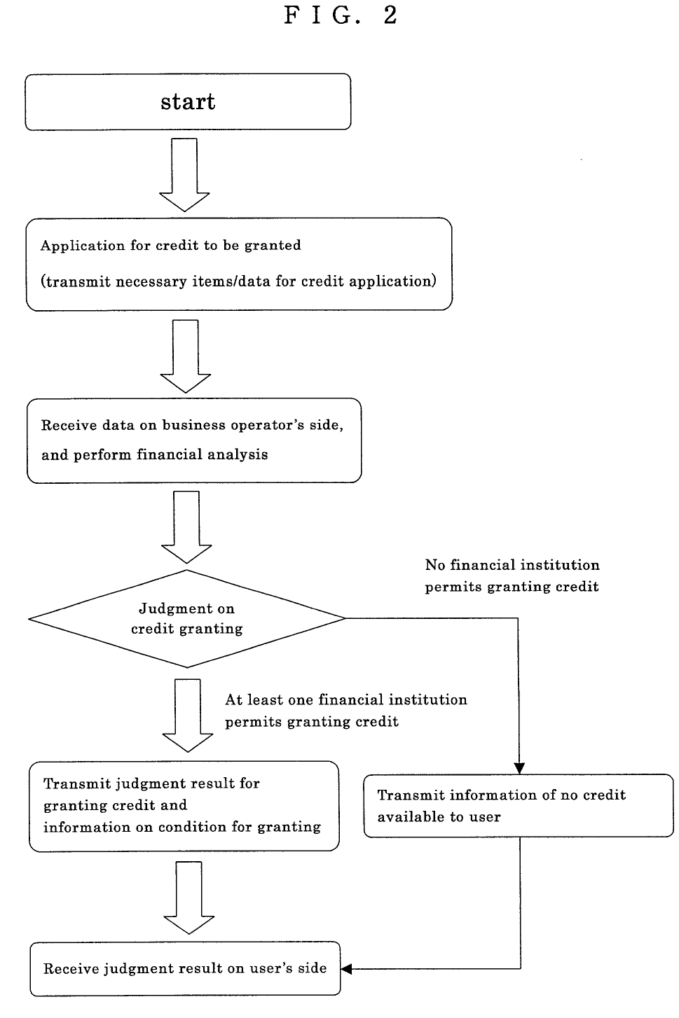

Referring now to a flow chart shown in FIG. 2, a description will be made of a concrete procedure of this credit granting system.

For instance, when a trading company, that is a user, wishes to borrow 14 million yen as fund for business operation, which is to be repaid on the five-year installment plan, the user accesses a website of the business-operator. Then, in accordance with the contents on the website, the user inputs information such as an a head office address, a name, a representative's name and e-mail address of the user, and the user's desired condition through a terminal of the user's computer by the use of a keyboard. In addition, by using a commercially available account software program, the user prepares its financial statement to transmit to the business-operator's computer, as attachments, data directly relating financial conditions such as a balance sheet and an income statement containing sales amount, ordinary profit, profit for the current term, and the like.

When the business-operator's computer receives the information and data from the user's computer, the business-operator's computer performs analysis on the financial condition of the trading company based on the received information and data, and judges whether or not the obtained analysis result satisfies the criteria for credit granting, which is preliminarily provided from the financial institution.

At that time, the business-operator's computer stores the criteria for credit granting provided from a plurality of financial institutions. Examples of the criteria are as follows:

A Credit Company: for financing 10 millions yen to 30 millions yen, this company sets minimum reference values for figures 1, 2, 5 to 8, 16 to 17, 23 to 24 of the above financial analysis data:

when minimum reference values for all the above figures are satisfied, a monthly rate is 1.85% on the five-year installment plan;

when one of the above values is not satisfied, a rate is 1.87%;

when two of the above values are not satisfied, a rate is 1.89%;

when three of the above values are not satisfied, a credit is not granted.

B Lease Company: for financing 10 millions yen to 15 millions yen, this company sets criteria for credit granting by use of the total points of figures 1, 3, 5 to 7, 9, 15 to 16, 23 to 24 of the above financial analysis data (each figure is converted into a point system on a scale of 10, in total of all the above figures on a scale of 100 for evaluation):

when a borrower obtains less than 50 points, no credit is granted;

when obtaining 50 to 59 points, a monthly rate is 1.92% on the five-year installment plan;

when obtaining 60 to 69 points, a rate is 1.90%;

when obtaining 70 to 79 points, a rate is 1.86%;

when obtaining not less than 80 points, a rate is 1.85%.

The criteria for credit granting provided from the financial institutions (this exemplary case includes five financial institutions) are compared with numerical data and/or score data as obtained in the above financial analysis. As a result, the credit granting judgments for the trading company, that is a user, are as follows:

| | |
|---|---|
| Company A | a credit of 14 millions yen is granted; |
| | a monthly rate is 1.89% on the five-year installment plan |
| | (264,600 yen) |
| Company B | a credit of 10 millions yen or less is granted; |
| | a monthly rate is 1.83% on the five-year installment plan |
| | (183,000 yen) |
| Company C | a credit of 14 millions yen is granted, but five-year |
| | installment plan is not accepted |
| | a monthly rate is 3.1% on three-year or less installment |
| | plan (434,000 yen) |
| Company D | a credit of 5 millions yen or less is granted; |
| | a monthly rate is 1.85% on the five-year installment plan |
| | (92,500 yen) |
| Company E | no credit is granted. |

Among these credit granting judgments, the user is informed of the financial institutions (“Companies” in this case) which grants a credit, by transmission from the business-operator's computer to the user's computer. At the same time, each of the financial institutions are informed via a communications line. With regard to a response to the user, it is preferred to indicate which institution is advantageous to the user by item of credit granting condition.

In other words, the judgment results may be placed in a list by financial institution, which grants the credit, and moreover by noticing, for example, which institution provides the lowest monthly rate (in the above example, Company B), which institution provides the largest credit amount (Companies A and C, in the above case), or which institution provides the longest credit term (Companies A, B, and D, in the above case), the user makes reference to these notices and establishes an agreement with a financial institution which provides a most optimum condition to the user.

Here, as a result of the credit granting judgments, in the case where no financial institution grants a credit to the user, such result is transmitted to the user's computer, while also the financial institutions concerned are notified of such result.

In accordance with the credit granting system of the present invention, the business-operator has tie-up with a plurality of financial institutions, and stores in the business-operator's computer credit granting criteria under which the financial institutions provide a credit to a user. When the business-operator receives an application for credit granting from a user's computer, a financial condition of the user is analyzed based on information and data sent from the user, and the obtained financial analysis is reviewed in comparison with the credit granting criteria given by each of the financial institutions. Then judgment is made on whether or not a credit is granted. Therefore, the user can withdraw an optimum condition for the credit (financing) to be granted based on the judgment results from the plurality of financial institutions only by one-time application. Furthermore, the financial institution can get a client who conforms to its credit granting criteria, even if that client does not have a usual transaction therewith.

In particular, according to the credit granting system of the present invention, a very simple mean like sending information and data for credit granting to the business-operator's computer, allows the user to know the availability of credit to be granted. In addition, on the financial institution's part, the present invention makes an examination period required for credit granting much shorter than the conventionally required one.

What is claimed is:

1. A credit granting system comprising:
a user's computer capable of transmitting both an information item and a data piece, which are required for providing a credit, and capable of receiving a judgment result information as to whether or not the credit can be provided; and
a business operator's computer connected via a communications line to said user's computer, capable of receiving the information item and the data piece transmitted from the user's computer, analyzing the received information item and data piece, comparing the analyzed result with a condition for credit provision which has been previously given by a financial institute, judging whether or not the credit can be provided, and transmitting the judgment result information to the user's computer.

2. A credit granting system according to claim 1 wherein:
the information item and data piece, required for credit provision, includes a user's requested condition pertaining to an amount of loan money and a loan period, an interest rate or the like, a financial statement, or an income-tax return, and a certificate of salary income.

3. A credit granting system according to claim 1 wherein:
the business operator's computer comprises an apparatus for receiving various sorts of information from the financial institute and for storing thereinto the received information.

4. A credit granting system according to any one of claims 1 and 2 wherein:
the business operator's computer comprises an apparatus capable of selecting only a financial institute which can provide the credit in deciding credit availability.

5. A credit providing method wherein:
the credit granting system as recited in any one of claims 1 to 4, is utilized.
